(19) United States
(12) Patent Application Publication
(10) Pub. No.: US 2009/0078845 A1
(43) Pub. Date: Mar. 26, 2009

(54) Vehicle cover restrainer

(76) Inventor: Richard M. Koszeghy, Hoboken, NJ (US)

Correspondence Address: OKTAY ENTERPRISES INTERNATIONAL, 2807 MULBERRY COURT, POUGHKEEPSIE, NY, 12603, US

(21) Appl. No.: 11/903,939

(22) Filed: Sep. 25, 2007

(51) Int. Cl. B60J 11/00

(52) U.S. Cl. 248/503; 150/166

(57) ABSTRACT

A restrainer device for securing vehicle covers. The device comprises a flexible stop-end and a lock-end, and a flexibly stiffened middle segment in between the elongate ends. The lock-end and the middle segment are placed thru one of the grommet openings of the vehicle cover and pulled thru until the stop-end is pressed against the grommet. The device is placed underneath the vehicle so as to span the width of the vehicle. The flexibly stiffened, semi-rigid segment retains a linear configuration, which allows for non-visual guidance of the lock-end from one side of the vehicle to the other. The lock-end is readily picked up and passed thru the grommet on the other side of the vehicle cover, and pulled thru creating a taut slack free connection and then padlocked. The device, including the flexibly-stiffened portion, can be rolled into a coiled state to allow for compact storage.

### BACKGROUND

All references cited in this specification, and their references, are incorporated by reference herein where appropriate for teachings of additional or alternative details, features, and/or technical background.

Disclosed is a restrainer device for securing vehicle covers. Vehicle covers may include those that are used to cover different types of vehicles, including automobiles, campers, trailers, trucks, SUVs, boats and airplanes where the restrainer device for securing the vehicle is passed underneath the vehicle from one side of the vehicle to the other side.

Vehicle covers of various shapes and forms are known in the art. They are used to protect vehicles from environmental encroachment, whether by nature or otherwise. The covers are designed to be oriented in place on the vehicle by engaging them to the various parts of the vehicles, such as to the side mirrors, bumpers or underside of the vehicle. The means of restraining the cover to the vehicle are provided with cables and other similar bands of fasteners that attach at one end to holes, or openings in the cover, while the other end traverses a portion of the vehicle and comes around to be attached to another opening or attachment point in the cover.

FIG. 1 shows an automobile 10 enclosed in cover 20. It is common to use a cover 20 provided with openings or holes 30, 35 around the periphery of the cover 20 such that when the cover is mounted on the car, hem 25, or the edges of the cover having the openings droop over the sides of the car. A first end 43 of a flexible fastener, such as a rope or cable symbolically represented by phantom line 40 in FIG. 1 is threaded into and pulled out of one of the openings, say 30 on one side of the cover until that first end 43 of the fastener is tightly secured to the first opening 30 in any number of ways such as making a loop and a knot at the opening (not shown). Then the free second end 45 of the fastener is tossed under the vehicle to reach the other side where the second end 45 is fished out from under the car and secured to an opening 35 on the opposite edge of the cover drooping on the other side of the car. The same procedure is repeated with one or more fasteners (not shown) to secure the cover to the vehicle.

In some cases, a flexible fastener 50 is provided with a loop 55 at first end and an eyelet 53 at the second end as shown in FIG. 2. The second end 53 is slipped through the first opening 30 in FIG. 3a and passed through loop 55 and pulled until the loop stops against the first opening 30 as better seen in FIG. 3b. The next step requires the passing of cable 50 under car 10 (which is usually accomplished by tossing the cable under the vehicle) and retrieving the eyelet-end 53 on the opposite side of the car. This is accomplished with some difficulty as shown in FIGS. 4a and 4b. After the second end 53 is fished out from under the other side of car 10, eyelet 53 is inserted into and pulled out from the second opening 35, and then secured to cover 20 by first passing the shank of an ordinary lock 60 through the eyelet 53 and then restraining cable 50 in opening 65 as the lock is closed shut, as better seen in FIG. 3c.

Short of restraining or securing a vehicle cover to the vehicle itself by modifying the vehicle to provide attachment points on the vehicle, the methods shown in FIGS. 1-3c are exemplary except for the difficulty in retrieving the fastener from underneath the vehicle after it has been tossed from one side to the other. When a commonly used fastener 50 shown in FIG. 4a is tossed under an automobile 10, for example, there is no assurance where the fastener will go. After a toss, it may take the position of fastener 50, or 50′. Most often than not, one has to go down on own knees, lean under the car and look to see where the fastener has ended up. Sometimes, a person 70 has to get down to the ground 80 on his/her back to retrieve the fastener, as depicted in FIG. 4b. What is needed, therefore, is an improved vehicle cover restrainer device that can be directed and passed in any desired direction under a vehicle easily and predictably while not compromising the ergonomic posture of an individual.

### REFERENCES

U.S. Pat. No. 7,204,280 to John Ellis Allen discloses a vehicle cover having a main cover portion with a plurality of peripheral edges, a fastening band attached along the plurality of peripheral edges which runs across the windshield, a pair of fastening band extensions extending under the side mirrors of the vehicle, and the fastening band extending down the length of the cover's side to secure the front end of the cover to the vehicle, and an anchoring means attached to the rear of the vehicle cover for securing the rear end of the cover to the trunk lid or a license plate frame.

U.S. Pat. No. 6,092,857 to Lawrence E. Rivas provides an automobile cover assembly incorporating a container that is adapted to be anchored to a portion of an automobile. The car cover assembly includes an anchor member in the form of an elongate pipe or tube that is attached to the container containing the cover via straps. The pipe is adapted to be deposited in the trunk of the automobile and the trunk lid can then be closed on the straps so as to anchor the container to the rear end of the automobile. The cover is stored within a cavity defined by the container and the cover includes a handle which is accessible by the user. The user grasps the handle and extracts the cover from the container while the container is anchored to the rear end of the automobile and then correctly positions the cover about the automobile.

U.S. Pat. No. 5,328,230 to Donald B. Curchod teaches a storable cover for covering the cabin portion of a variety of vehicles, such as sedans, vans, and hatchbacks, carries storage means secured thereto to be disposed in a suitable compartment of the vehicle. The trailing edge of the cover is anchored inside the vehicle when the cover is disposed onto the vehicle. The storage means is affixed firmly inside the trunk or other rear compartment of the various vehicles, such as for example, sedans, hatchbacks, and vans so as to locate part of the over assembly within a locked compartment. The cover is deployed by being taken out of the storage means and fed from the trunk through the opening which is created between the raised closure member for the compartment and the body of the vehicle.

U.S. Pat. No. 3,953,911 to Walter F. Fishack shows an elastic tie cord attached to a fastener to form an infinitely adjustable tie cord assembly. A finger aperture is provided on the fastener for applying tension to the cord in cooperation with a remote loop at the other end of the cord. A hook on the fastener adjacent the finger aperture includes a curved, tapered slot narrowing to an opening having a width less than the normal diameter of the cord. The cord is tensioned around an object to be secured and the reduced cord diameter is wedged into the slot opening at any desired point on the cord. Upon release of the finger aperture and the remote loop, the cord diameter beyond the fastener returns to normal, wedging the cord firmly in the slot to maintain tension on the portion of the cord around the secured object. The eyelet and the curved slot opening are aligned with the axis of tension of the cord so that the tensioned cord partially pivots the fastener about the cord axis of tension to project the finger aperture upward from the secured object, thereby facilitating access to the finger aperture. An alternate embodiment of the invention includes a fastener having a T-bar shaped appendage for gripping to apply tension. A wedge-shaped aperture is disposed at the base of the T-bar having a narrow vertex for securing the tensioned cord.

U.S. Pat. No. 7,210,726 to Vincent J. Merlot, et. al, describes a retractable cover system comprising: a flexible cover. A plurality of supporting bows support the cover. A semi-rigid member having first and second ends is secured to the cover section. The semi-rigid member is capable of flexing laterally outward if the system is retracted. This outward action allows the cover or cover sections to consistently fold in the same way and prevents the cover or cover sections from getting caught in the load or in the cover system componentry. The invention also comprises a segmented tube secured to the bottom portion of the cover between the bows.

### SUMMARY

Aspects disclosed herein include

a restrainer device for securing a vehicle cover comprising flexibly stiffened tubing having a first head at one end and a second head at the opposite end; coiled spring disposed lengthwise in the tubing; a fastener having a first end and a second end disposed inside the coiled spring; a first cap with an opening covering the first head of the tubing; a second cap with an opening covering the second head of the tubing; the first end of the fastener protruding from the opening of the first cap of the tubing; the second end of the fastener protruding from the opening of the second cap of the tubing; the first end of the fastener having a blocking device; and the second end of the fastener having a locking device.

a restrainer device for securing vehicle cover comprising an elongate implement having a first portion, a second portion and a third portion, each the portions having a first end and a second end; wherein the second end of the first portion is connected to the first end of the second portion, thus leaving the first end of the first portion as a first free end; the second end of the second portion is connected to the first end of the third portion, thus leaving the second end of the third portion as a second free end; the first portion further comprising a flexible member having the first free end; the second portion further comprising a semi-rigid member; the third portion further comprising a flexible member having the second free end; wherein the first free end of the first portion is fixedly attached to a blocking device; and the second free end of the third portion is fixedly attached to a locking device.

a method providing an elongate device having a flexibly stiffened semi-rigid member connected at one end to a first flexible member having a first free end, and connected at its opposite end to a second flexible member having a second free end, the first free end having a blocking device and the second free end having a locking device; providing a vehicle and a vehicle cover having a first grommet opening on a first side and a second grommet opening on a second side opposite the first side; placing the vehicle cover over the vehicle with the sides of the vehicle cover extending downwards on the sides of the vehicle; inserting the locking device into the first grommet opening of the vehicle cover; pulling the locking device, the second flexible member, the semi-rigid member and the first flexible member, in that order, until the blocking device is captured snugly against the first grommet opening; placing the semi-rigid member and the second flexible member under the vehicle; using the semi-rigid member to guide the second flexible member to the other side of the vehicle; picking up the second flexible member having the locking device at the second end from the other side of the vehicle; inserting the locking device into the second grommet opening in the cover; pulling the locking device until the blocking device on the first side of the cover is adjustably taut; and locking the slack in the second flexible member in a swage-lock and padlocking.

### BRIEF DESCRIPTION OF DRAWINGS

FIG. 1 shows a vehicle cover installed on an automobile, according to prior art.

FIG. 2 shows a conventional cable for securing the cover of FIG. 1 onto a vehicle.

FIGS. 3a-3c show the securing of a vehicle cover, according to prior art.

FIGS. 4a-4b show the installation of a vehicle cover, according to prior art.

FIGS. 5a-5b show the installation of a vehicle cover in accordance with an embodiment of the present disclosure.

FIGS. 6a-6b show the securing or restraining of a vehicle cover in accordance with an embodiment of the present disclosure.

FIGS. 7a-7b show two views of an embodiment of the present disclosure where the disclosed restrainer device in its normally straight semi-rigid state can be rolled into a coiled state for storage.

FIGS. 8a-8b show cross-sectional views of the embodiments shown in FIGS. 7a-7b.

FIGS. 9a-9b is another embodiment showing the locking device for the presently disclosed restrainer apparatus for securing a vehicle cover.

### DETAILED DESCRIPTION

In embodiments there is illustrated:

a restrainer device for securing protective covers over vehicles in particular, or over objects to be covered in general.

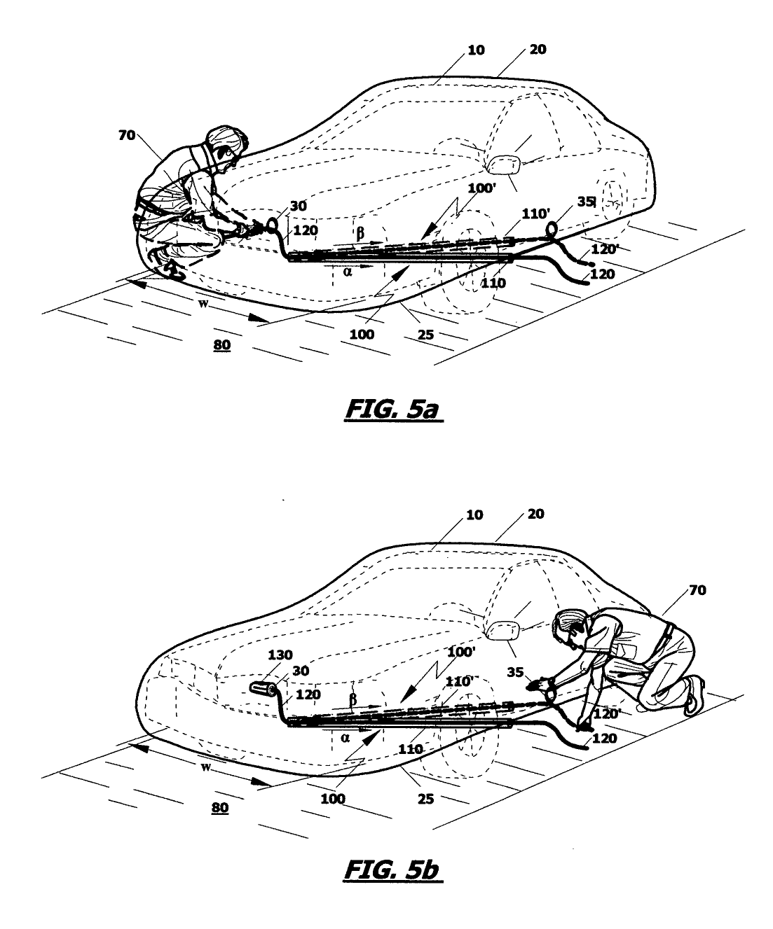

The restrainer device, hereafter designated as 100 in the drawings, comprises a flexible fastener 120, such as a wire or a cable, inserted inside and protruding from both ends of a straight and flexibly stiffened, semi-rigid tubing 110 (disclosed in more detail later) of sufficient length to span the width w of vehicle 10 to be enclosed under cover 20 shown in FIG. 5a. The protruding ends of the fastener 120 are adapted to be engaged to openings 30, 35, such as grommet holes, provided on the hem, or edges 25 of the protective cover 20. The device is placed underneath the vehicle body from one side of the vehicle 10 and the flexible fastener 120 protruding on that side is secured to one of a plurality of openings on the cover. The other end of fastener 120, as guided by the straight and flexibly stiffened tubing 110 underneath the vehicle is readily found exposed on the opposite side of the vehicle. The exposed end of the fastener is then secured to one of a plurality of openings on that side of the cover.

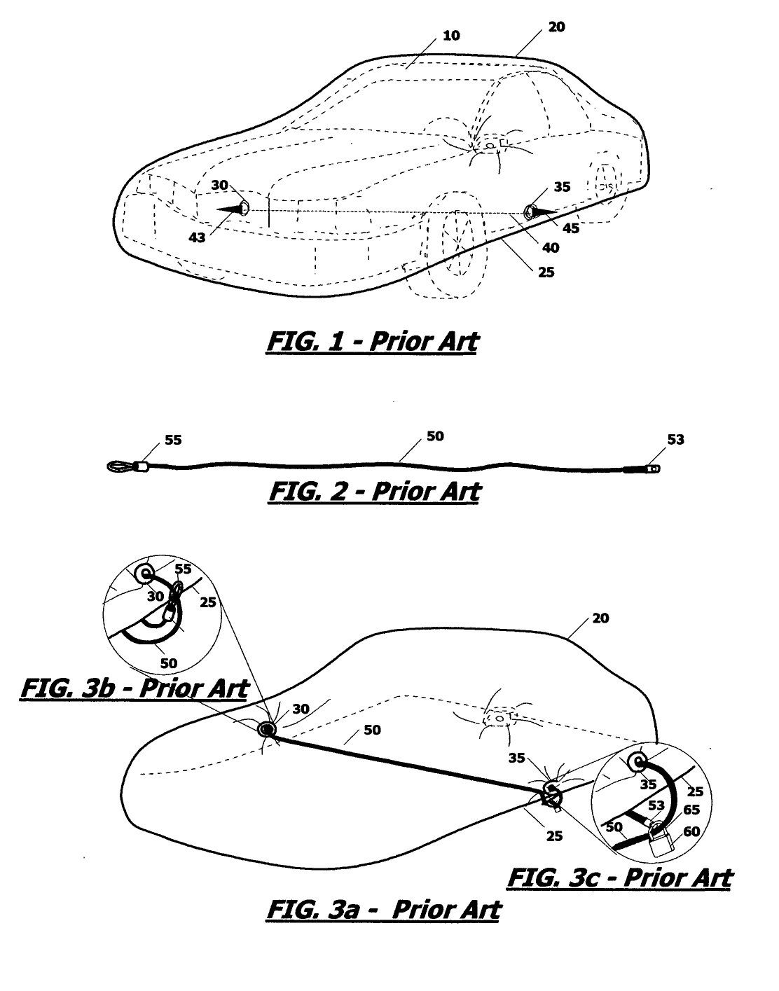

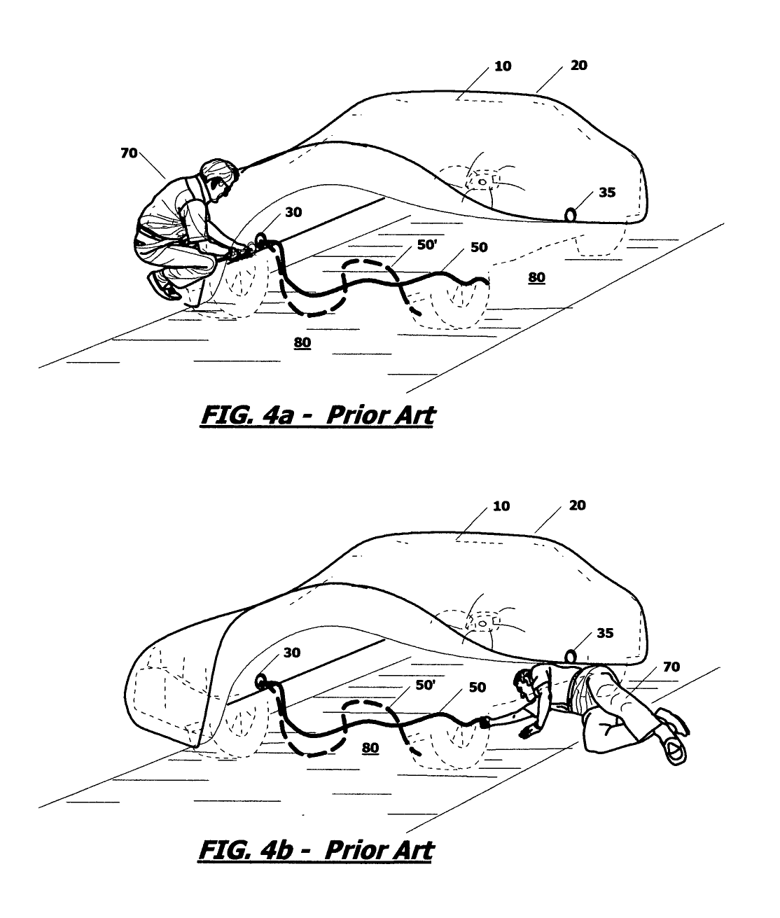

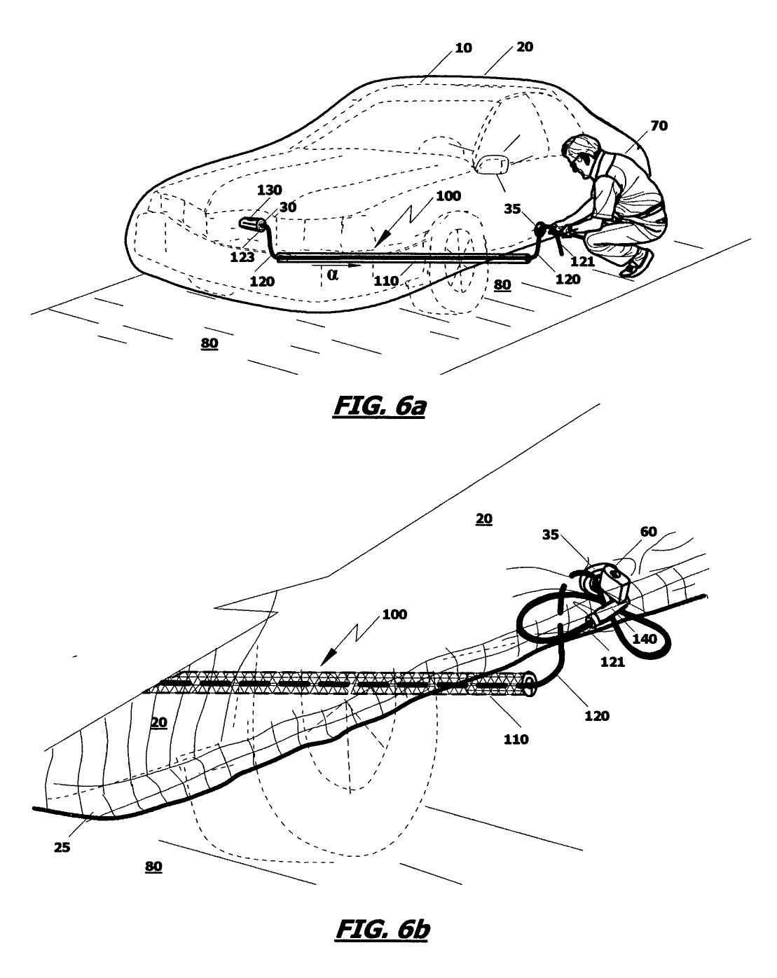

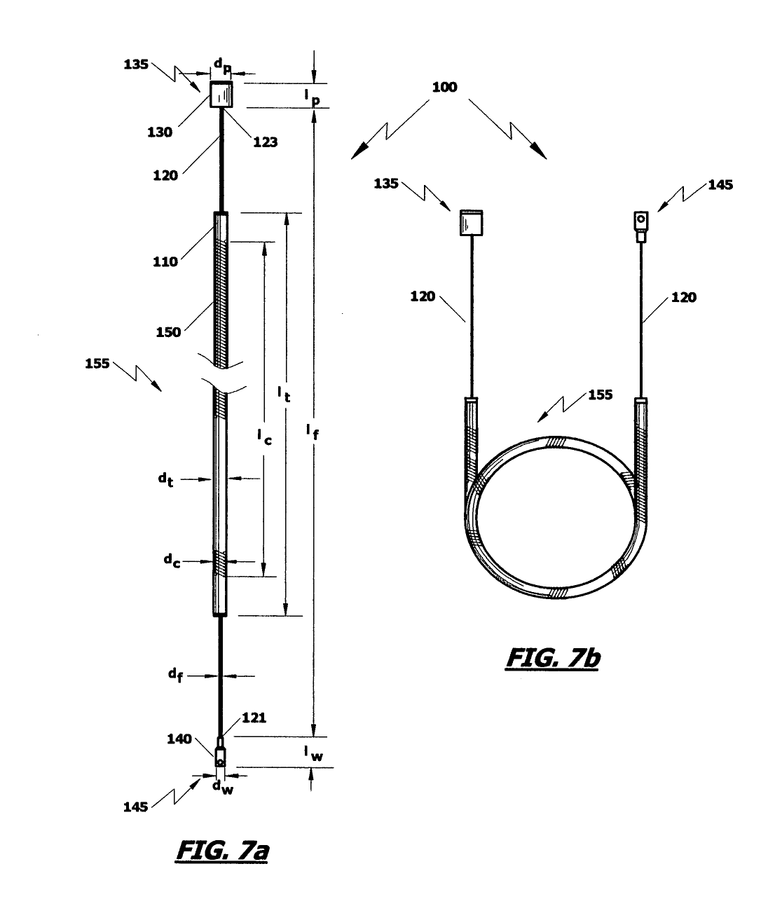

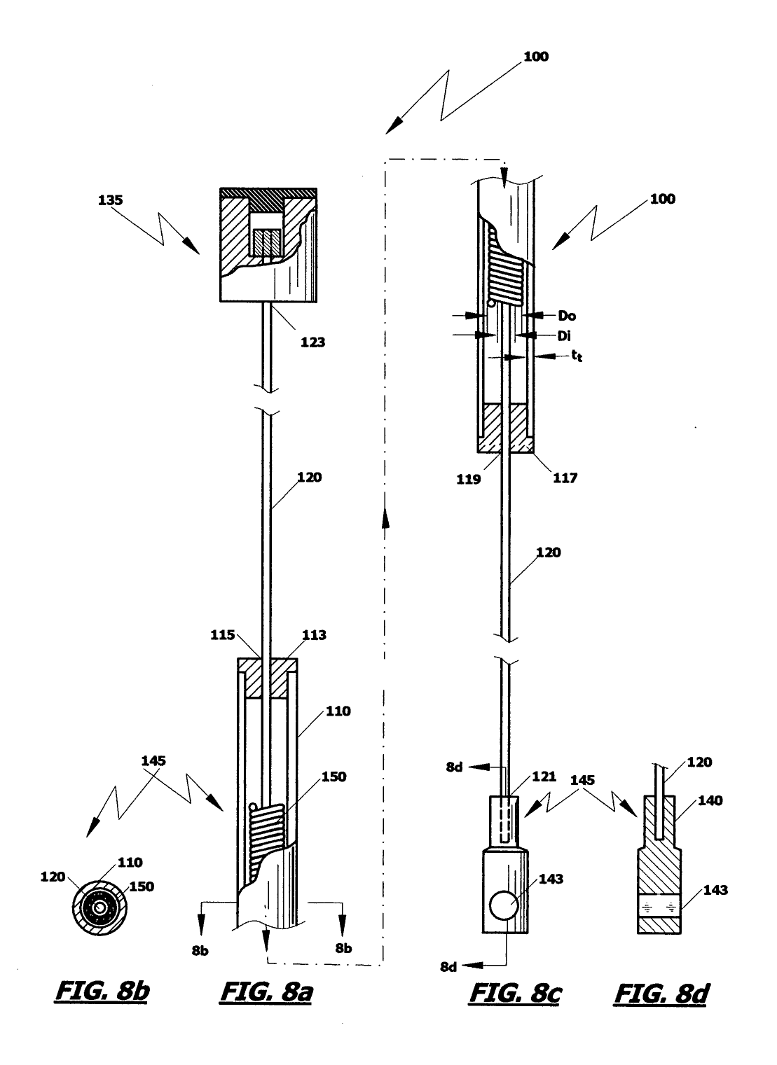

FIG. 5a depicts a user 70 of device 100 holding one end of the fastener 120 after having inserted the other end of the fastener and the outer tubing 110 through opening 30 and laying down device 100 on the ground beneath vehicle 10. Because of the flexibly stiffened semi-rigidity of the further disclosed cover restraining device 100, the user 70 is able to point the device 100 in any desired direction, say in α or β directions shown in FIGS. 5a and 5b towards the other side of the vehicle. It is now a matter of picking up the other end of the fastener 120 or 120′ on the other side of the vehicle dose to the grommet opening 35, depending upon the direction, α or β, in which the device was laid down on the ground, i.e., in position 100 or 100′, respectively, and securing the other second end to opening 35 on the other side of the vehicle. It will be noted that both in inserting the device 100 into a first opening 30 of the cover 20, laying the device on the ground underneath the vehicle 10 afterwards, and then picking up the other end of the fastener 120 or 120′ from the device on the other side of the vehicle, all are accomplished with ease by either crouching or normal bending or leaning, as depicted in FIGS. 5a and 5b, in contrast to the supine positions that may be taken with commonly used devices shown in FIGS. 1-4b. In FIGS. 6a-6b, the same crouching position (or any other ergonomically comfortable position, for that matter) is used to secure vehicle cover 20 on vehicle 10 by inserting a first locking end 121 in opening 35, pulling the opposite stopping end 123 against a stop-plug 130 at the other end, forming loops to take up any slack and securing the loop in a locking element 140, and locking it up 60, as further described below in reference to FIGS. 7a-8d.

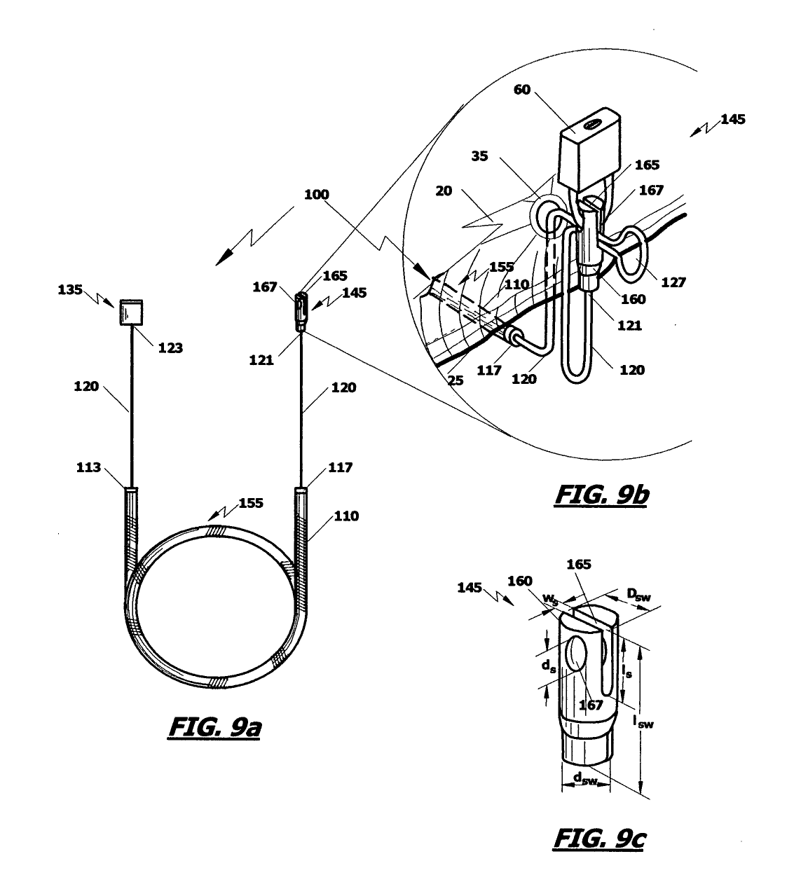

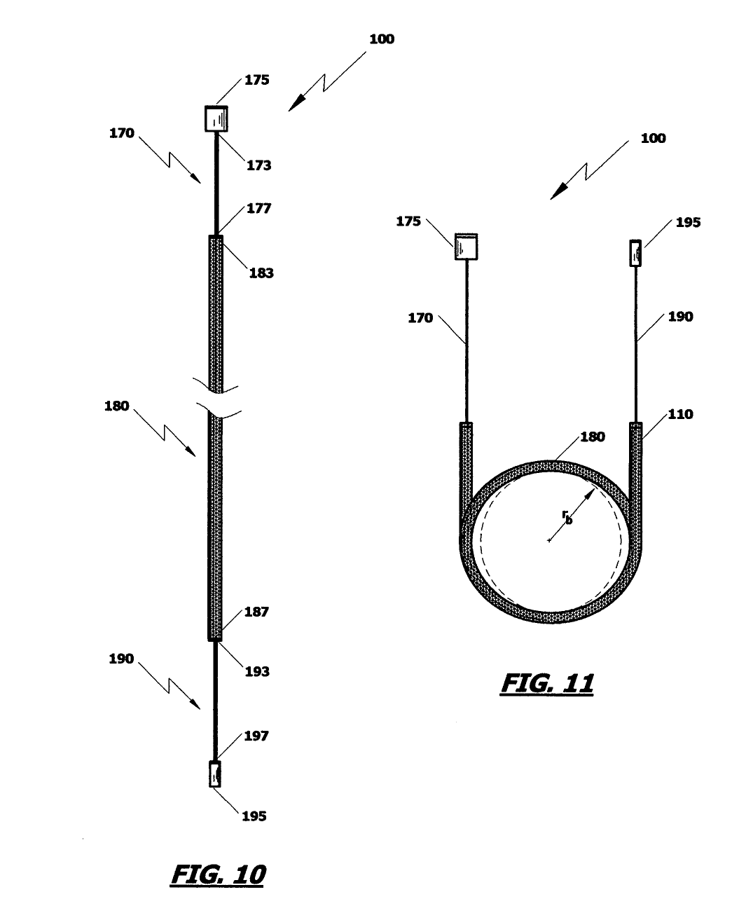

The ability to direct cover restrainer device 100 easily in any desired direction under vehicle 10 for immediate retrieval (from an opposite side of the vehicle as described earlier) without “fishing around” on the ground is accomplished by the disclosed embodiments in FIGS. 7a-8d. In one embodiment shown in FIG. 7a, cover restraining device 100 comprises three portions: a stop-end 135, a lock-end 145 and a middle portion 155, also shown separately in FIG. 7b. In a further embodiment, the middle portion 155 is flexibly stiffened by placing a coiled spring 150 inside an outer tubing 110, thus forming a semi-rigid assembly 155. A fastener 120 in the form of a cable is inserted through spring 150 inside tubing 110. A first end 123 of fastener 120 is fixedly fitted with a stop-plug 130, thus forming the stop-end 135, while a second end 121 is fixedly fritted with a locking element 140, such as an eyelet or a swage-lock, thus forming the lock-end 145 as described further in FIGS. 9a and 9b.

Tubing 110 is generally long enough to span the width w of the vehicle 10 to be covered and can be flexibly rolled into a coiled state for easy storage, as shown in FIG. 7b. The outer dimensions of the disclosed device 100, including that of the tubing 110 and the locking element 140 at one end of the fastener 120 are such that the whole device, except for the stop-plug 130 at the stop-end 123, can be inserted through the openings, such as 30 and 35 provided on the vehicle cover 20. The diameter of grommet openings in commonly used vehicle covers range from about 4.8 mm to 38.1 mm (millimeters). The various dimensions of the presently disclosed device 100 are also shown in FIGS. 8a-8d.

Specifically, one embodiment of the present disclosure provides a flexible vinyl tubing 110 having a wall thickness tₜ of between about 1 mm and 3.2 mm, outside diameter, dₜ, between about 9.9 mm to 31.8 mm and a length, lₜ between about 1.4 m to 1.7 m (meters), although it will be appreciated that other types of flexible tubing can also be used. Also, the length lₜ can be between about 2.4 m and 2.6 m for large trucks. FIG. 5b shows a cross-section of the flexibly stiffened semi-rigid assembly 155 of the present disclosure.

Another embodiment of the present disclosure provides a spring 150 which is inserted inside tubing 110 in order to give the tubing a stiff and yet flexible characteristics so that the combination of the tubing 110 together with the spring 150 results in a device which can be controlled as a mostly rigid and straight implement while it can also be rolled into a coiled state. The stiffness k of spring 150 in relation to its length l_{c} is chosen to obtain the desired effect of stiffness as well as the required flexibility by using the well-known relationship

$$k = \frac{{Gd}^{4}}{8 {D}^{3} {n}_{a}}$$

where G is the shear modulus of the spring material, nₐ is the number of active spring coils, d is the diameter of the coils, D, the diameter of spring 150, and where the length l_{c} can be calculated from the number and diameter of the coils. The length of the spring, l_{c}, is also governed by the length, lₜ, of the tubing 110, for if l_{c} is too long, then the freely moving spring 150 inside tubing 110 can push out the end-caps 113 and 115 (shown in FIGS. 8a, 8c) when rolled into a coiled state shown in FIG. 7b. In meeting these criteria, a galvanized steel spring 150 having a length lₜ between about 1.2 m to 2.1 m, outside diameter Dₒ of about 7.9 mm and inside diameter Dᵢ of about 4.8 mm was chosen. It will be noted that other spring materials with other dimensions can also be used commensurate with the desired characteristics of the cover restrainer device 100.

Another embodiment provides a flexible vinyl coated cable 120 having a diameter, d_{f}, between about 3.2 mm and 12.7 mm and a length, l_{f}, between about 1.7 m and 2.1 m or 2.7 m for a truck. Other types of flexible fasteners and diameters may also be used. End-caps 113 and 117 close the ends, or heads of tubing 110 as shown in FIGS. 8a and 8c, enclosing the coiled spring 150 inside the vinyl tubing while allowing the vinyl cable 120 pass through central openings 115 and 119, respectively. End-caps 113 and 117 are inserted into each end of the vinyl tubing 110 and preferably glued. Friction fit may also be utilized, with or without a glue treatment.

The cylindrical stop-plug 130 at the stop-end 135 of restrainer device 100 shown in FIG. 8a comprises plastic material having a length lₚ between about 25.4 cm and 76.2 cm (centimeters) and diameter between about 19.1 mm and 50.8 mm, larger than the commonly used grommet opening 30. It will be known to those skilled in the art that the stop-plug can also be made out of metal covered with plastic in order to avoid scratching the body of the vehicle during installation of the cover over the vehicle. The lock-end 145 is fixedly fitted with an eyelet type element shown 140 in FIG. 8d.

Still another embodiment of the present disclosure provides a swage-lock device 160, which is incorporated onto the lock-end 145 of cover restrainer device 100 as shown in FIGS. 9a and 9b. It will be understood by those skilled in the art that other types of locking devices can be incorporated onto the cover restrainer device 100 of the present disclosure. The other stop-end 135 of the cover restrainer device 100 is fitted with stop-plug 130, described earlier.

The disclosed swage-lock device 160 is better seen in the enlarged view of FIG. 9b. In FIG. 9b, cover restrainer device 100 is shown suspended under vehicle cover 20 mounted on an automobile 10 (not shown). The end-cap 117 of the flexibly stiffened tubing 110 can also be seen protruding from underneath the hem 25 of vehicle cover 25. Fastener 120, emanating from the end cap 117 of tubing 110, has attached to its second end 121 the swage-lock 160 which enters and exits the grommet opening 35 from behind the vehicle cover 20, as shown in FIG. 9b. The diameter of swage-lock 160 is commensurate with the diameter of the grommet openings 30 at the stop-end 135 and 35 at the lock-end 145 shown in FIG. 9a so as to be able to enter and exit both openings 30 and 35 freely, and easily. Following the grommet dimensions of the present market place, it is preferred that the outer diameter D_{sw} of swage-lock 160 is between about 9.5 mm and 38.1 mm.

In operation, after the swage-lock 160 is inserted in grommet 30 on one side of cover 20 as shown in FIG. 6a, followed by inserting the remaining portions of the cover restrainer device 100, including the flexibly stiffened tubing 110, the lock-end 145 is directed under vehicle 10 towards the other side of cover 20 with the aid of the flexibly stiffened semi-rigid assembly 155. The swage-lock 160 attached to the second end 121 of the fastener 120 is then readily retrieved from underneath the vehicle 10, as shown in FIG. 9b. The swage-lock 160 is next inserted into grommet opening 35 from behind the hem 25 of vehicle cover 20 and the lock-end 145 of fastener 120 pulled until the stop-plug 130 of stop-end 135 is snug against grommet opening 30 of cover 20 on the opposite side of vehicle 10.

Another embodiment of the present disclosure provides a slot 165 in the swage-lock 160 that enables the adjustment of the tension of cover restrainer device 100 prior to securing the device to cover 20. Subsequent to passing the end 121 and swage-lock 160 through grommet opening 35, the user, while holding the fastener 120 taut, slips the slack in fastener 120 into slot 165 shown in FIGS. 9b and 9c and folds over the remaining slack and inserts it back into slot 165, thus creating a loop 127. Next, the user inserts the shank 65 of a padlock 60 through opening 167 in the swage-lock 160 as shown in FIG. 9b, thus capturing the loop 127 inside the slot 165. Because the size of the of the swage-lock 160 in combination with padlock 60 is larger than the grommet opening 35, the fastener 120 can no longer be pushed back into the opening 35. In addition, when shank 65 of padlock 60 is inserted into opening 167, shank 65 creates only enough space within the slot 165 for two fastener 120 diameters. Hence, the size of shank 65 does not allow the loop 127 to be pulled out of the slot 165, but does allow for the tension of the fastener between grommet openings 30 and 35 to be adjusted and set.

The swage-lock 160 shown in FIG. 9c preferably comprises plastic; or it can be made out any suitable metal covered with plastic to avoid scratching the vehicle during the installation of the protective cover on the vehicle. The outer diameter D_{sw} of the swage-lock 160 is between about 9.5 mm to 38.1 mm. It will be understood that diameter D_{sw} can be varied to accommodate the grommet openings of vehicle covers found in the market place at a given time. The smaller diameter d_{sw} shown in FIG. 9s is between about 6.4 mm to 25.4 mm. The over-all length l_{sw} of the swage-lock 160 is between about 33.2 mm to 117.8 mm, while the length lₛ of slot 165 of the swage-lock 165 is between about 12.7 mm to 55.2 mm. The width wₛ of slot 165 is between about 3.2 mm to 12.7 mm. The diameter dₛ of the opening 167 in slot 165 is between about 3.2 mm to 19.1 mm.

The stated embodiment of the coiled state of the present disclosure as shown in FIGS. 7b and 9c enables the cover restrainer device 100 to be stored conveniently in a storage bag and/or the trunk of a vehicle. Furthermore, the stop-plug of fastener 120 can be left hooked onto grommet opening 30, for example, on one side of the protective cover 20 so that both the cover and the cover restrainer device 100 can be stored together. The assembly (not shown) of cover 20 and the cover restrainer device 100 can be kept either in a coiled state or in an extended state with the aid of a strap. In this manner, at the time of the next use, cover 20 can be unfurled exposing the flexibly stiffened semi-rigid tubing 110 ready to be directed to the underside of the vehicle 10 and readily picked up on the other side of the vehicle for passing the swage-lock 160 through the other grommet opening 35 for securing the cover restrainer device 100 to the cover 20 securely with padlock 60, as shown in FIG. 9b.

Though these numerous details of the disclosed cover restrainer device are set forth here, such as the flexibly stiffened semi-rigid characteristics and the dimensional parameters, to provide an understanding of the present invention, it will be obvious, however, to those skilled in the art that these specific details need not be employed to practice the present invention in other similar applications that are too many to cite, such as, for example, varying the dimensional parameters to accommodate vehicles of different shapes and uses, such as automobiles and pick-up trucks. Furthermore, the various parts of the restrainer device 100 may not necessarily have to be insulated with plastic tubing, when used with certain vehicles. For instance, the spring portion 150 of the semi-rigid part of restrainer device 100 of FIG. 7a need not be inserted into plastic tubing 110 to protect the bottom side of a truck from damage by the spring. On the other hand, the spring itself may be coated with plastic, obviating separate plastic tubing around the spring. At the same time, it will be evident that the same characteristics and parameters may be employed in other similar applications that are too many to cite, such as, for example, using protective covers for automobiles, SUVs, vans, trucks, boats and airplanes.

It will also be understood that the restrainer device 100 for securing a vehicle cover may comprise an elongate implement having a first member 170, a second member 180 and a third member 190, as shown in FIGS. 10 and 11. The first member 170 has a first end 173 and a second end 177, the second member 180 has a first end 183 and a second end 187, and the third member 190 has a first end 193 and a second end 197. The second end 177 of the first member 170 is connected to the first end 183 of the second member 180, thus leaving the first end 173 of the first member 170 as a first free end. The second end 187 of the second member 180 is connected to the first end 193 of the third member 190, thus leaving the second end 197 of the third member 190 as a second free end. The first member 170 further comprises a flexible member having a the first free end 173 while the second member 180 further comprises a semi-rigid member. The third member 190 further comprises a flexible member having the second free end 197. The first free end 173 of the first member 170 is fixedly attached to a blocking device 175, and the second free end 197 of the third member 190 is fixedly attached to a locking device 195. In the embodiments shown in FIGS. 10 and 11, while the stiffness of the semi-rigid member 180 determines the controllability of the cover restraining device 100 in directing the locking device 195 from one side of vehicle 10 to the other, as described above, the flexibility of the same second member 180 determines the size of the coil that the restraining device 100 altogether can be rolled into. The parameter that incorporates the stiffness together with the flexibility is the bend radius, as described in detail in the articles published by the National Electrical Code (NEC) and the Insulated Cable engineers Association (ICEA). In an article provided by Anixter on the Internet http://www.anixter.com/AXECOM/AXEDocLib.nsf/(UnID)/71C22AE23FF1A43580256F240 06EF67A/$file/B-17.pdf has the minimum bend radius r_{d} is defined as the distance from the center of an imaginary circle that “snuggles” onto the inside surface of the cable bend, as shown in FIG. 11. The minimum bend radius r_{d} is found to be multiples of the diameter of the flexible member. For single or multiple conductor cables without metallic shielding, the bend radius is found to be 8 times the overall cable diameter, while for single conductor cables with shielding the bend radius is found to be 12 times the overall diameter. It has been found experimentally that the bend radius of the disclosed flexible members 170 and 190 is 8 times their diameters, while the bend radius of the semi-rigid member is 121 times its own diameter. Accordingly, it is preferred that flexible members 170 and 190 have a bend radius r_{d} between about 23 mm and 39 mm and semi-rigid member, between about 11 cm and 13 cm.

While the invention has been particularly shown and described with reference to particular embodiment(s), it will be appreciated that variations of the above-disclosed embodiment(s) and other features and functions, or alternative thereof may be desirably combined into many other different systems or applications. Also various presently unforeseen or unanticipated alternative, modifications, variations or improvements therein may be subsequently made by those skilled in the art which are also intended to be encompassed by the following claims.

What is claimed is:

1. A restrainer device for securing vehicle cover comprising
a flexibly stiffened tubing having a first head and a second head;
a coiled spring disposed in said tubing;
a fastener having a first end and a second end disposed inside said coiled spring;
a first cap with an opening covering said first head of said tubing;
a second cap with an opening covering said second head of said tubing;
said first end of said fastener protruding from said opening of said first cap of said tubing;
said second end of said fastener protruding from said opening of said second cap of said tubing;
said first end of said fastener having a blocking device; and
said second end of said fastener having a locking device.

2. The device according to claim 1, wherein said tubing comprises plastic tubing.

3. The device according to claim 2, wherein said plastic tubing has a length between about 1.4 m and 1.7 meters and between about 2.4 mm and 2.6 mm for large trucks.

4. The device according to claim 2, wherein said plastic tubing has an outside diameter between about 9.9 mm and 31.8 mm.

5. The device according to claim 2, wherein said plastic tubing has an inside diameter between about 7.9 mm and 25.4 mm

6. The device according to claim 1, wherein said coiled spring comprises galvanized steel.

7. The device according to claim 1, wherein said coiled spring has a length between about 1.2 m and 2.1 m.

8. The device according to claim 1, wherein said coiled spring has an outside diameter between about 7.9 mm and 25.4 mm.

9. The device according to claim 1, wherein said coiled spring has an inside diameter between about 4.8 mm and 19 mm.

10. The device according to claim 1, wherein said fastener comprises vinyl coated steel cable.

11. The device according to claim 1, wherein said fastener has a length between about 1.7 m and 3.5 m.

12. The device according to claim 1, wherein said fastener has a diameter between about 3.2 mm and 12.7 mm.

13. The device according to claim 1, wherein said blocking device comprises a plastic plug.

14. The device according to claim 1, wherein said locking device comprises a swage-lock.

15. An apparatus comprising
an elongate implement having a first member, a second member and a third member, each said members having a first end and a second end; wherein
said second end of said first member is connected to said first end of said second member, thus leaving said first end of said first member as a first free end;
said second end of said second member is connected to said first end of said third member, thus leaving said second end of said third member as a second free end;
said first member further comprising a flexible member having said first free end;
said second member further comprising a semi-rigid member;
said third member further comprising a flexible member having said second free end; wherein
said first free end of said first member is fixedly attached to a blocking device; and
said second free end of said third member is fixedly attached to a locking device.

16. The apparatus according to claim 15, wherein said flexible member has a bend radius between about 21 mm and 41 mm.

17. The apparatus according to claim 15, wherein said semi-rigid member has a bend radius between about 11 cm and 17 cm.

18. The apparatus according to claim 15, wherein said blocking device comprises a plastic plug.

19. The apparatus according to claim 15, wherein said locking device comprises a swage-lock.

20. A method comprising the steps of
providing an elongate device having a flexibly stiffened semi-rigid member connected at one end to a first flexible member having a first free end, and connected at its opposite end to a second flexible member having a second free end, said first free end having a blocking device and said second free end having a locking device;
providing a vehicle and a vehicle cover having a first grommet opening on a first side and a second grommet opening on a second side opposite the said first side;
placing said vehicle cover over said vehicle with said sides of said vehicle cover extending downwards on the sides of said vehicle;
inserting said locking device into said first grommet opening of said vehicle cover;
pulling said locking device, said second flexible member, said semi-rigid member and said first flexible member, in that order, until said blocking device is captured snugly against said first grommet opening;
placing said semi-rigid member and said second flexible member under said vehicle;
using said semi-rigid member to guide said second flexible member to said other side of said vehicle;
picking up said second flexible member having said locking device at said second end from said other side of said vehicle;
inserting said locking device into said second grommet opening in said cover;
pulling said locking device until said blocking device on said first side of said cover is adjustably taut; and
locking the slack in said second flexible member in a swage-lock and padlocking.
